(19) United States
(12) Patent Application Publication
(10) Pub. No.: US 2025/0276391 A1
(43) Pub. Date: Sep. 4, 2025

(54) BAND SAW

(71) Applicant: MILWAUKEE ELECTRIC TOOL CORPORATION, Brookfield, WI (US)

(72) Inventors: Samuel J. Becker, Wauwatosa, WI (US); Carmen J. Castanos, Shorewood, WI (US); Anthony R. Sleck, Lisbon, WI (US)

(21) Appl. No.: 19/066,989

(22) Filed: Feb. 28, 2025

Related U.S. Application Data
(60) Provisional application No. 63/654,455, filed on May 31, 2024.
(60) Provisional application No. 63/560,176, filed on Mar. 1, 2024.

(51) Int. Cl. B23D 53/04; B23D 55/02; B23D 55/04

(52) U.S. Cl. CPC B23D 53/049; B23D 55/02; B23D 55/04

(57) ABSTRACT

A benchtop band saw including a base, a clamp assembly configured to hold a workpiece, a support arm pivotably coupled to the base about a miter axis extending perpendicular to the base, and a band saw moveable relative to the support arm and the base between a raised position and a lowered position for performing a cutting operation. The band saw has a housing defining an opening in which the workpiece is partially receivable, a motor, a first wheel supported by the housing for rotation about a first wheel axis, a second wheel supported by the housing for rotation about a second wheel axis, and a band saw blade. The miter axis is located within a reference plane oriented parallel to the first wheel axis and the second wheel axis. The reference plane extends through the opening when the band saw is in at least the lowered position.

### CROSS-REFERENCE TO RELATED APPLICATIONS

This application claims priority to U.S. Provisional Patent Application No. 63/654,455, filed May 31, 2024, and U.S. Provisional Patent Application No. 63/560,176, filed Mar. 1, 2024, the entire contents of both of which are incorporated herein by reference.

### FIELD OF THE INVENTION

The present invention relates to power tools, and more specifically to band saws.

### BACKGROUND OF THE INVENTION

Benchtop band saws are used to cut a variety of workpieces, such as pipes, rods, studs, and blocks. Benchtop band saws typically include a base and a band saw pivotably coupled to the base for cutting the workpieces.

### SUMMARY OF THE INVENTION

In some aspects, the techniques described herein relate to a benchtop band saw including: a base; a clamp assembly coupled to the base and configured to hold a workpiece; a support arm pivotably coupled to the base about a miter axis that extends perpendicular to the base; and a band saw coupled to the support arm and moveable relative to the support arm and the base between a raised position and a lowered position for performing a cutting operation on the workpiece, the band saw including a housing defining an opening in which the workpiece is at least partially receivable during the cutting operation, a motor positioned within the housing, a first wheel supported by the housing for rotation about a first wheel axis, the first wheel being coupled to the motor to receive torque therefrom, a second wheel supported by the housing for rotation about a second wheel axis, and a band saw blade extending around the first wheel and the second wheel and traveling in a continuous loop around the first wheel and the second wheel, the band saw blade traversing the opening in the housing, wherein the miter axis is located within a reference plane oriented parallel to each of the first wheel axis and the second wheel axis, and wherein the reference plane extends through the opening in the housing when the band saw is in at least the lowered position.

In some aspects, the techniques described herein relate to a benchtop band saw including: a base; a clamp assembly coupled to the base and configured to hold a workpiece; and a band saw moveably coupled to the base between a first position and a second position, the band saw including a housing having a first end moveably coupled to the base, an opposite, second end, and an opening in which the workpiece is at least partially receivable during a cutting operation, the opening being located between the first end and the second end, a motor positioned within the housing, a first wheel supported by the housing for rotation about a first wheel axis, the first wheel being coupled to the motor to receive torque therefrom, a second wheel supported by the housing for rotation about a second wheel axis, a band saw blade extending around the first wheel and the second wheel and traveling in a continuous loop around the first wheel and the second wheel, the band saw blade traversing the opening in the housing and configured to cut the workpiece as the band saw moves from the first position to the second position, a handle coupled to the housing proximate the first end, the handle having a mount portion fixed to the housing and a grip portion extending transverse to the mount portion, the grip portion including a rear surface facing the first end of the housing, and a trigger protruding from the rear surface of the grip portion of the handle, the trigger being configured to actuate the motor when depressed.

In some aspects, the techniques described herein relate to a benchtop band saw including: a base; a clamp assembly coupled to the base and configured to hold a workpiece; and a band saw moveably coupled to the base, the band saw including a housing having a first end moveably coupled to the base, an opposite, second end, and an opening in which the workpiece is at least partially receivable during a cutting operation, the opening being located between the first end and the second end, a motor positioned within the housing, a first wheel supported by the housing for rotation about a first wheel axis, the first wheel being coupled to the motor to receive torque therefrom, a second wheel supported by the housing for rotation about a second wheel axis, a band saw blade extending around the first wheel and the second wheel and traveling in a continuous loop around the first wheel and the second wheel, the band saw blade traversing the opening in the housing and configured to cut the workpiece, and a blade guard movably coupled to the housing between a first position and a second position, wherein the blade guard is preloaded against the housing to lock the blade guard in a desired position when the blade guard is motionless.

In some aspects, the techniques described herein relate to a benchtop band saw including: a base; a clamp assembly coupled to the base and configured to hold a workpiece; and a band saw moveably coupled to the base, the band saw including a housing having a first end moveably coupled to the base, an opposite, second end, and an opening in which the workpiece is at least partially receivable during a cutting operation, the opening being located between the first end and the second end, a motor positioned within the housing, a drive wheel assembly rotationally driven by the motor, the drive wheel assembly including a drive wheel and a driven wheel, a band saw blade extending around the drive wheel assembly and traveling in a continuous loop around the drive wheel assembly, the band saw blade configured to pass through the opening of the housing to cut the workpiece, and a blade guide assembly coupled to the housing and configured to support the band saw blade as the band saw blade passes through the opening, the blade guide assembly including a first bearing set disposed on a first end of the opening and a second bearing set disposed on a second end of the opening, wherein the first bearing set includes a first bearing and a second bearing separated from each other by a gap within which the band saw blade is supported, and wherein the first bearing is adjustable relative to the second bearing to adjust a width of the gap.

### BRIEF DESCRIPTION OF DRAWINGS

FIG. 1 is a front perspective view of a benchtop band saw according to an embodiment of the present invention.

FIG. 2 is a rear perspective view of the benchtop band saw of FIG. 1.

FIG. 3 is a front perspective view of the benchtop band saw of FIG. 1, showing a band saw with portions removed.

FIG. 4 is a back perspective view of the benchtop band saw of FIG. 1, showing a band saw with portions removed.

FIG. 5 is a front perspective view of a handle of the benchtop band saw of FIG. 1.

FIG. 6 is a cross-sectional view of the benchtop band saw of FIG. 1, showing a drive wheel assembly.

FIG. 7 is a back perspective view of the benchtop band saw of FIG. 1, showing a table with portions removed.

FIG. 8 is a front perspective view of a table of a benchtop band saw according to another embodiment of the invention.

FIG. 9 is a side view of the benchtop band saw of FIG. 1, showing the benchtop band saw moving from a raised position to a lowered position.

FIG. 10 is a front perspective view of a band saw according to another embodiment of the invention.

FIG. 11 is a rear perspective view of the band saw of FIG. 10.

FIG. 12 is an enlarged view of the band saw of FIG. 10 illustrating a blade guard disposed in a first position.

FIG. 13 is a front perspective view of the blade guard of FIG. 12.

FIG. 14 is a rear perspective view of the blade guard of FIG. 12.

FIG. 15 is a cross-sectional view of the blade guard of FIG. 12 through section line 15-15 in FIG. 10, the blade guard is coupled to a housing of the band saw of FIG. 10.

FIG. 16 is an enlarged view of the band saw of FIG. 10, illustrating a blade guide assembly.

FIG. 17 is a perspective view of a first bearing set of the blade guide assembly of FIG. 16.

Before any embodiments of the invention are explained in detail, it is to be understood that the invention is not limited in its application to the details of construction and the arrangement of components set forth in the following description or illustrated in the following drawings. The invention is capable of other embodiments and of being practiced or of being carried out in various ways. Also, it is to be understood that the phraseology and terminology used herein is for the purpose of description and should not be regarded as limiting.

### DETAILED DESCRIPTION

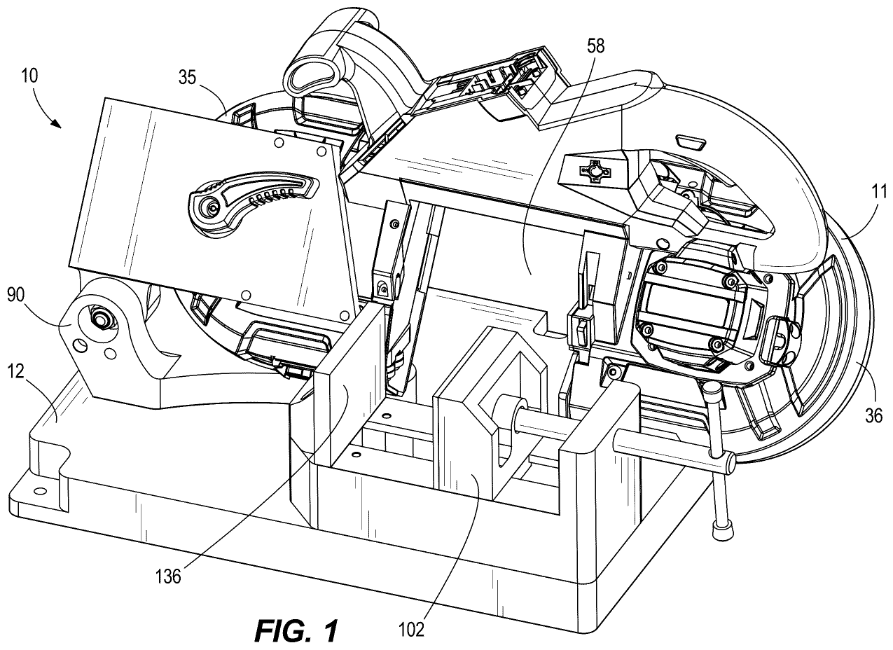

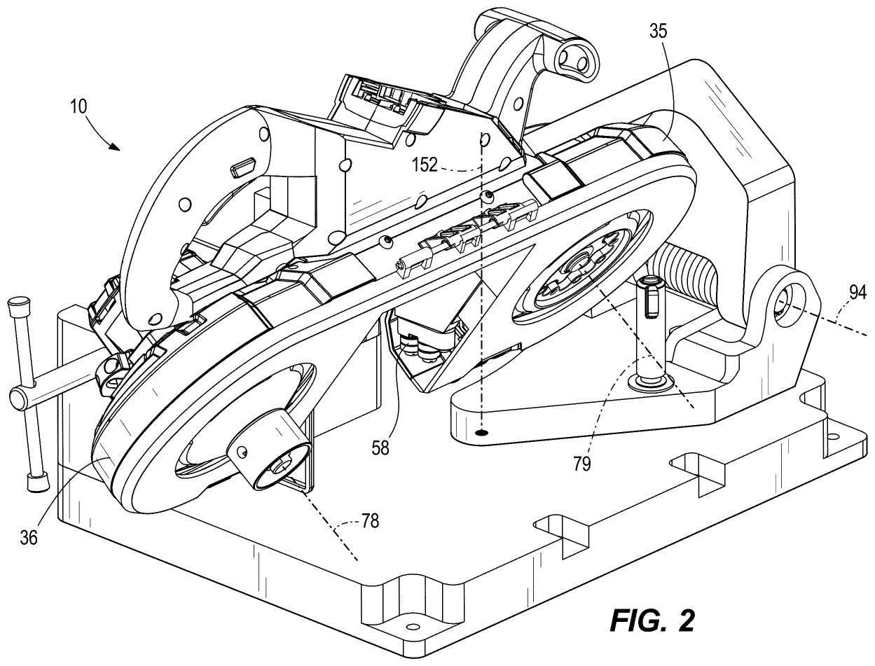

FIGS. 1 and 2 illustrate a benchtop band saw 10 including a band saw 11 pivotably coupled to a table 12. The band saw 11 is configured to pivot between a raised position and a lowered position for performing a cutting operation (shown in FIG. 9) on a workpiece.

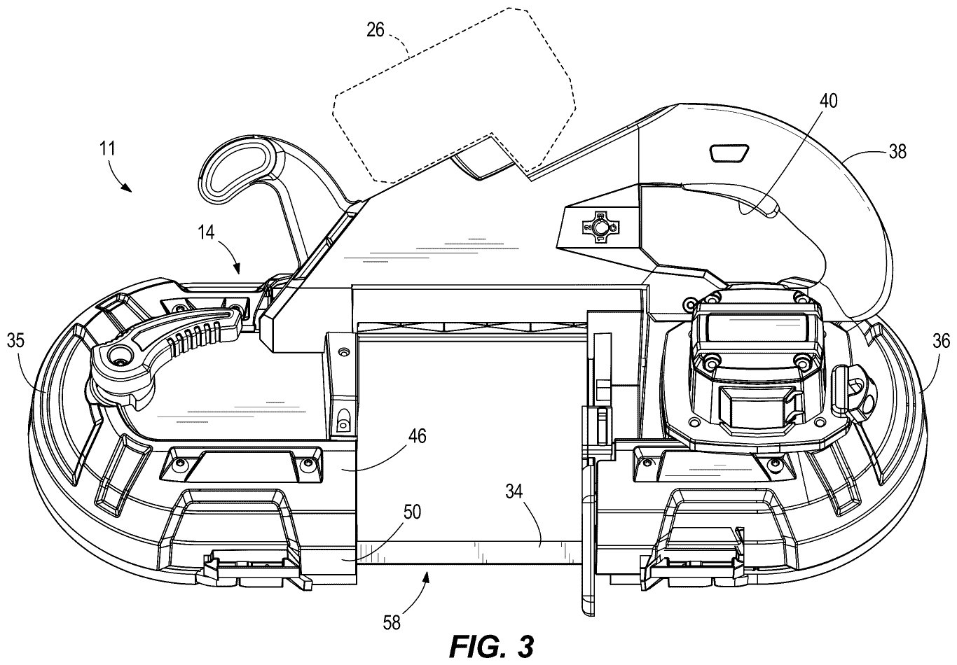

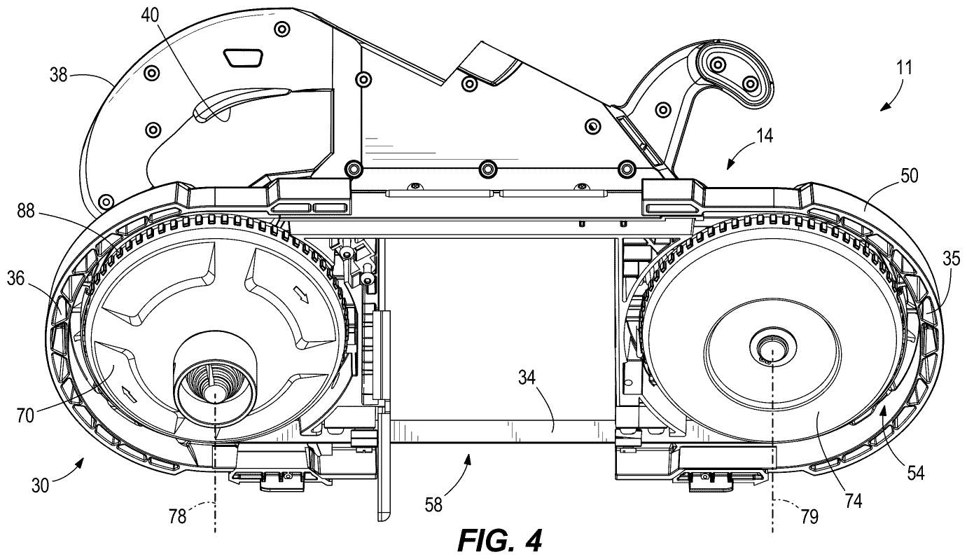

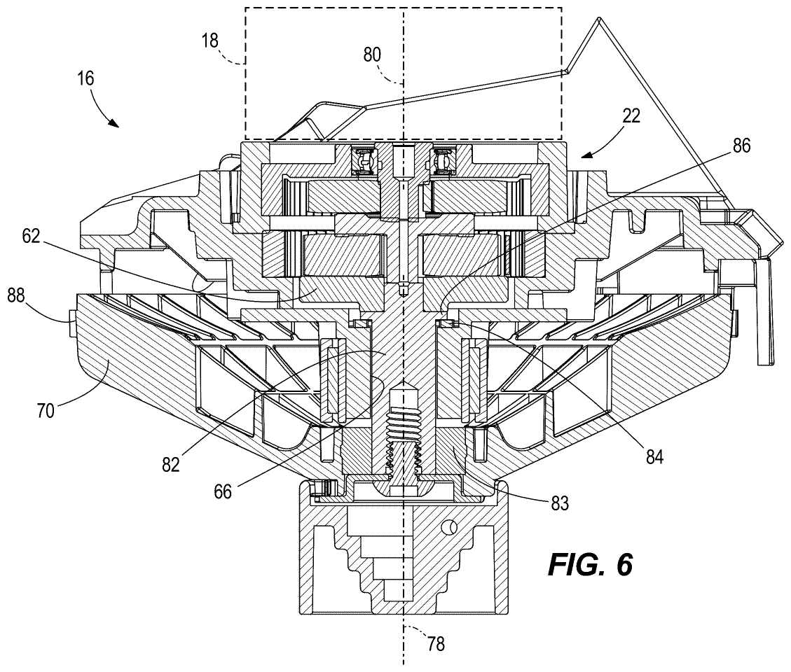

FIG. 3 illustrates a band saw 11 including a frame or housing 14 supporting a drive mechanism 16 (FIG. 6). The drive mechanism 16 includes a motor 18 and a transmission 22. In some embodiments of the band saw 11, the motor 18 is configured as a brushless DC (BLDC) electric motor and the band saw 11 includes a removable, rechargeable battery pack 26 (FIG. 3) for supplying power to the motor 18. In other embodiments, the rechargeable battery pack 26 may be located elsewhere in the benchtop band saw 11, such as on the table 12. With reference to FIG. 4, the drive mechanism 16 further includes a drive wheel assembly 30, which is driven by the motor 18 via the transmission 22. In the illustrated embodiment, the motor 18, the transmission 22, and the drive wheel assembly 30 are supported by the housing 14, but may be elsewhere in other embodiments. The transmission 22 may include different gear train arrangements configured to provide a low-speed, high-torque output from the high-speed, low-torque input of the motor 18. The drive mechanism 16 is operable to drive a continuous band saw blade 34 to cut a workpiece.

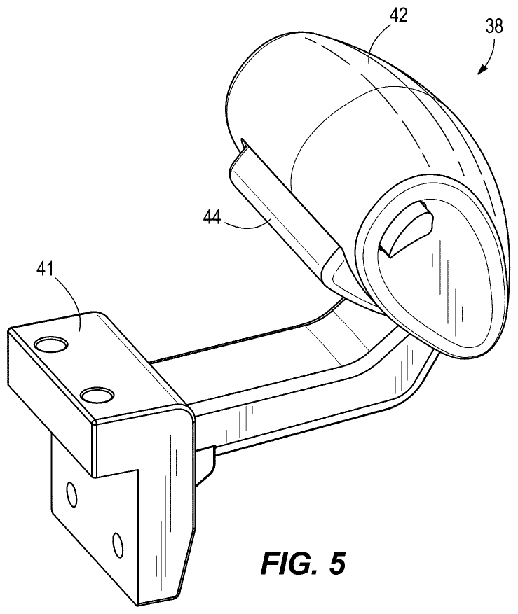

With reference to FIGS. 3 and 4, the housing 14 extends between a first end 35 that is pivotably coupled to the table 12 and an opposite, second end 36. The housing 14 includes a handle 38 coupled to the housing 14 proximate the second end 36. In some embodiments, the handle 38 is a D-shaped handle with a trigger 40 disposed on an inner surface of the handle 38. As shown in FIG. 5, in other embodiments, the handle 38 may be a pommel handle 38 having a mount portion 41 fixed to the housing 14 and a grip portion 42 extending transverse to the mount portion 41. The grip portion 42 includes a rear surface facing the first end 35 of the housing 14. The handle 38 is provided with a trigger 44 to selectively supply power to the band saw 11. The trigger 44 protrudes from the rear surface of the grip portion 42 of the pommel handle 38. When the trigger 44 is depressed, the motor 18 is activated. In the illustrated embodiment of the band saw 11, the battery pack 26 is supported by the housing 14 between the first end 35 and the second end 36. In other embodiments, the battery pack 26 may be supported elsewhere on the housing 14 or offboard the housing 14, including on the table 12.

With reference to FIG. 3, the housing 14 also includes a deck 46 and a guard 50 coupled to the deck 46. The deck 46 and the guard 50 form a cavity 54 (FIG. 4) in which the drive wheel assembly 30 and the band saw blade 34 are at least partially positioned. The housing 14 also defines an opening 58 disposed between the first end 35 of the housing 14 and the second end 36 of the housing 14. In some embodiments, the opening 58 is positioned at a center of the housing 14. In other embodiments, the opening 58 is offset from the center of the housing 14. The deck 46 and the guard 50 substantially cover the band saw blade 34 when the band saw blade 34 is in a shielded position (i.e., when the band saw blade 34 is not within the opening 58; FIG. 4). However, the deck 46 and the guard 50 do not cover the band saw blade 34 when the band saw blade 34 is in an exposed position (i.e., when the band saw blade 34 performs the cutting operation). In the exposed position, the band saw blade 34 is fully exposed and unobstructed by the guard 50, allowing workpieces to be cut when entering the opening 58. In other words, the band saw blade 34 traverses the opening 58 such that the workpiece is partially received the opening 58 during the cutting operation.

With reference to FIG. 4, the drive wheel assembly 30 includes a drive wheel 70 that is driven by the motor 18 and a driven wheel 74 that is driven by the drive wheel 70 via the band saw blade 34. Specifically, the band saw blade 34 extends around the drive wheel 70 and the driven wheel 74 such that rotation of the drive wheel 70 rotates the band saw blade 34, which thereby rotates the driven wheel 74. Portions of the drive wheel 70 and the driven wheel 74 are covered by the deck 46 and the guard 50. The opening 58 is positioned between the drive wheel 70 and the driven wheel 74 such that the band saw blade 34 traverses the opening 58. The drive wheel 70 rotates about a drive wheel axis 78 defined by a drive wheel spindle 82 (FIG. 6). The driven wheel 74 rotates about a driven wheel axis 79 (FIG. 4) that is parallel with the drive wheel axis 78.

At one end, the drive wheel spindle 82 is coupled for co-rotation with a carrier 62 of the transmission 22 which, in the illustrated embodiment of the band saw 11, includes a multi-stage planetary gear train. At the other end, the drive wheel spindle 82 is keyed to the drive wheel 70, such that the drive wheel spindle 82 and the drive wheel 70 co-rotate. In other embodiments, a third wheel may be positioned between the drive wheel spindle 82 and the drive wheel 70 for co-rotation therewith to increase the cutting capacity of the band saw 11. The drive wheel spindle 82 also extends from the transmission 22 through an aperture 66 in the deck 46. The aperture 66 is diametrically larger than the drive wheel spindle 82, such that the aperture 66 does not engage or support the drive wheel spindle 82. The drive wheel spindle 82 is axially supported by a thrust bearing 84 adjacent the carrier 62. Specifically, the thrust bearing 84 engages and axially supports a flange 86 extending radially outward from the drive wheel spindle 82. The drive wheel spindle 82 is radially supported by a roller bearing 83 disposed adjacent the aperture 66. The flange 86 is disposed between the carrier 62 and the thrust bearing 84. Therefore, the drive wheel 70 is drivingly connected to the motor 18 via the transmission 22 and the drive wheel spindle 82. In the illustrated embodiment of the band saw 11, a rotational axis 80 of the motor 18 is coaxially aligned with the drive wheel axis 78. In other embodiments, the motor rotational axis 80 and the drive wheel axis 78 may be parallel or at some other oblique angle relative to each other. A tire 88 is coupled to the outer peripheral surface of each of the wheels 70, 74 (although only one of which is shown). Each tire 88 grips the band saw blade 34 to drive motion thereof.

With reference to FIGS. 1 and 2, the band saw 11 is pivotably coupled to the table 12 by a support arm 90, as explained in greater detail below. The band saw 11 is pivotably coupled to the support arm 90 about a chop axis 94 (FIG. 2) defined between the raised position and a lowered position for performing the cutting operation on the workpiece, as shown in FIG. 9. In the raised position, the band saw 11 is angled relative to the table 12. In the lowered position, the band saw 11 is parallel with the table 12.

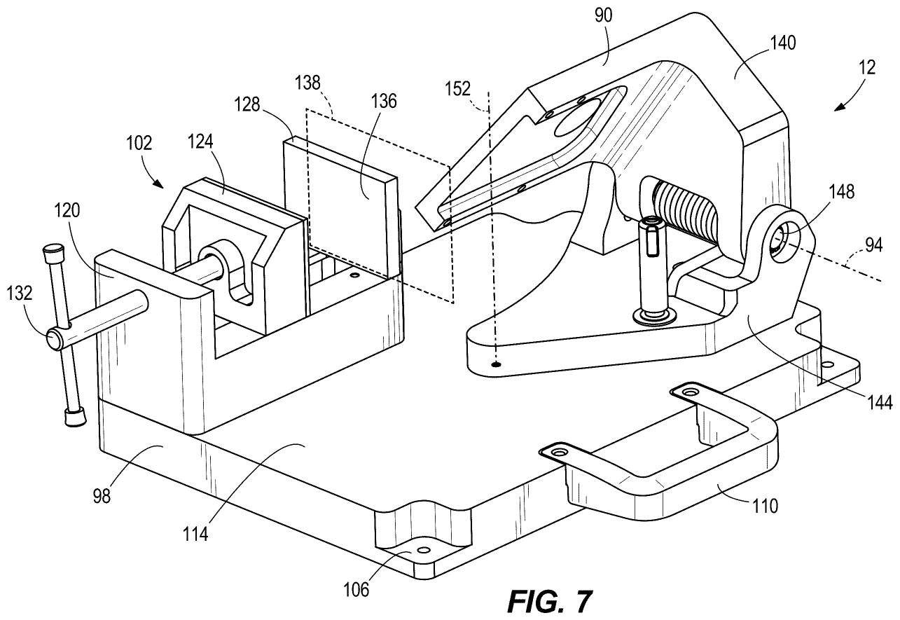

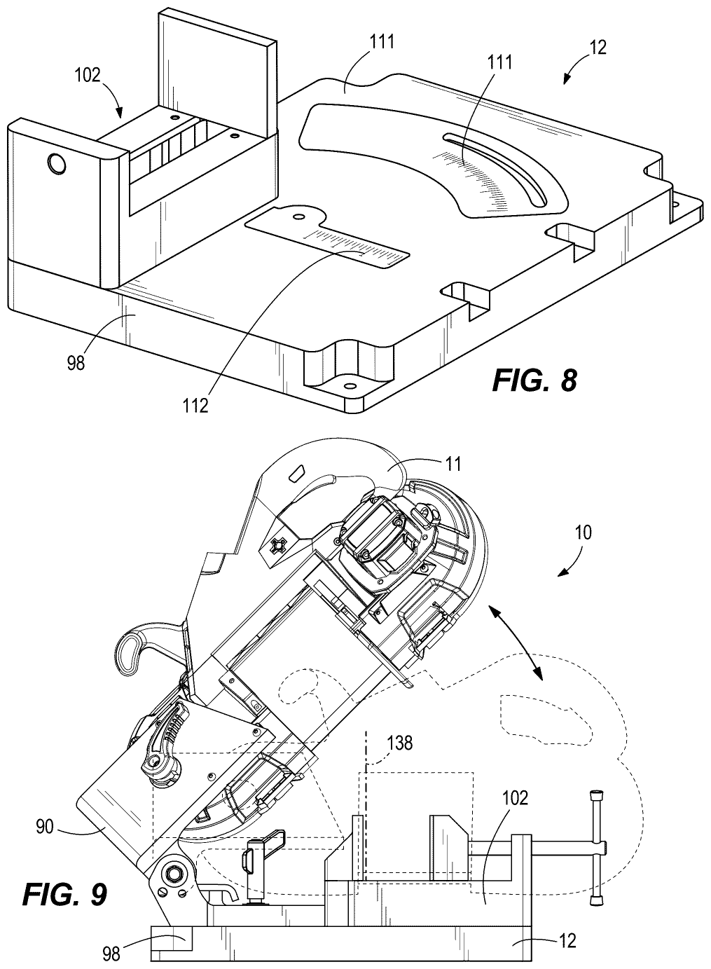

With reference to FIG. 7, the table 12 includes a base 98 and a clamp assembly 102 affixed to the base 98. The base 98 is configured to act as a stand for the band saw 11. More specifically, the band saw 11 is supported by the base 98 during the cutting operation. The base 98 includes mounting apertures 106 for optionally securing the base 98 a workbench. In some embodiments, the mounting apertures 106 are disposed at corners of the base 98. In other embodiments, the mounting apertures 106 may be disposed at alternative locations in the base 98. The table 12 additionally includes a handle 110 for carrying the benchtop bandsaw 10. In the illustrated embodiment, the handle 110 is disposed at a side of the base 98 opposite the clamp assembly 102. In some embodiments, the base 98 may include measurement indicia, such as a miter angle scale 111 and a material cut-off scale 112, located on a top surface 114 of the base 98 (FIG. 8). In some embodiments, the base 98, the handle 110, and a portion of the clamp assembly 102 may be integrally formed as a single piece.

The top surface 114 of the base 98 defines a base plane. The band saw 11 is angled relative to the base plane. Specifically, drive wheel axis 78 and the driven wheel axis 79 are oriented at an oblique angle relative to the base plane (FIG. 2). In some embodiments, the drive wheel axis 78 and the driven wheel axis 79 may be angled at 45 degrees relative to the base plane. In other embodiments, the drive wheel axis 78 and the driven wheel axis 79 may be angled at between 45 degrees and 90 degrees relative to the base plane. In further embodiments, the drive wheel axis 78 and the driven wheel axis 79 may be angled at between 0 degrees and 45 degrees relative to the base plane.

With reference to FIG. 7, the clamp assembly 102 holds the workpiece in place relative to the table 12 during a cutting operation. The clamp assembly 102 includes a clamp base 120, a first, movable jaw 124 slidable relative to the clamp base 120, and a second, stationary jaw 128. In some embodiments, the clamp base 120 includes mounting holes through which fasteners are inserted to secure the clamp base 120 to the base 98. In other embodiments, such as that shown in FIG. 8 the clamp base 120 may be integrally formed with the base 98 (e.g., by a casting process). With reference to FIG. 7, the clamp assembly 102 also includes a rotatable screw 132. The rotatable screw 132 is received in a threaded aperture in the clamp base 120. Rotating the screw 132 slides the first jaw 124 along a surface of the clamp base 120 toward or away from the second jaw 128 to adjust a clamping force applied to a workpiece between the jaws 124, 128. The second jaw 128 includes a flat surface 136 against which the workpiece is held when the workpiece is being clamped by the clamp assembly 102. The flat surface 136 defines a vertical plane 138 that is perpendicular to the base plane. As shown in FIG. 9, the vertical plane 138 extends through the opening 58 in the band saw housing 14 in each of the raised position and the lowered position. In operation, the rotatable screw 132 is rotated such that the first jaw 124 moves away from the second jaw 128. The workpiece is placed between the first jaw 124 and the second jaw 128. The rotatable screw 132 is rotated such that the first jaw 124 moves toward the second jaw 128. Once the first jaw 124 is touching the workpiece and the second jaw 128 is touching the workpiece, the workpiece is held by the clamp assembly 102 such that the cutting operation may be performed.

The support arm 90 includes a band saw mount 140 pivotably coupled to a support arm base 144 via a pivot joint 148. In other embodiments, the band saw mount 140 may be slidably coupled to the support arm base 144 such that the band saw 11 may translate relative to the base 98. In other embodiments, the support arm 90 may include additional components between the base 98 and the band saw 11. The band saw mount 140 is coupled to the first end 35 of the band saw 11 via fasteners. In the illustrated embodiment, the pivot joint 148 defines the chop axis 94 for the band saw 11. In other embodiments, the chop axis 94 may be defined elsewhere on the band saw 10. The chop axis 94 extends parallel to the base 98. In other embodiments, the chop axis 94 may extend perpendicular to the base 98. In other embodiments, the chop axis 94 may extend at an alternative angle relative to the base 98. The pivot joint 148 includes detents that engage with pins to hold the band saw 11 in one or more discrete positions between the raised position and the lowered position shown in FIG. 9, and prevent the band saw 11 from pivoting beyond a predetermined range. Specifically, the pivot joint 148 includes a first detent (not shown) that engages with a hard-stop bolt (not shown) when the band saw 11 is at a 0 degree chop angle relative to the base plane. Therefore, the first detent prevents the band saw 11 from coming into contact with the base 98. The pivot joint 148 also includes a second detent (not shown) that engages with the hard stop bolt when the band saw 11 is at a 45 degree chop angle relative to the base plane. Therefore, the band saw 11 is solely moveable between 0 degrees and 45 degrees relative to the base plane. When the band saw 11 is at the 0 degree chop angle, the band saw 11 is in the lowered position. When the band saw 11 is at the 45 degree chop angle, the band saw 11 is in the raised position. In other embodiments, the pivot joint 148 may allow an alternative range of motion for the band saw 11.

The second detent additionally may engage with a lock-down pin (not shown) when the band saw 11 is at the 0 degree chop angle relative to the base plane. The lock-down pin holds the band saw 11 at the 0 degree chop angle when a user moves the lock-down pin into the second detent. Therefore, the band saw 11 can be locked at the 0 degree chop angle for transporting or carrying the benchtop bandsaw 10. The pivot joint 148 also includes a third detent (not shown) that may engage with the lock down pin when the band saw 11 is at a 30 degree chop angle relative to the base plane. The lock-down pin holds the band saw 11 at the 30 degree chop angle when the user moves the lock-down pin into the third detent. This allows the user to lock the band saw 11 in place so that the user can move the workpiece. In other embodiments, the pivot joint 148 may include additional and/or alternative detents for locking the band saw 11 in place. Additionally, the detents may be disposed at alternative locations such that the band saw 11 is held at differing angles than the angles disclosed above.

With reference to FIG. 7, the support arm base 144 is pivotably coupled to the base 98 about a miter axis 152 that extends perpendicular to the base plane. The miter axis 152 extends perpendicular to the chop axis 94. The support arm 90 is pivotably coupled to the base 98 via an eccentric pivot (not shown). The eccentric pivot allows the support arm 90 to move linearly along the base plane and to rotate about the miter axis 152. Specifically, the eccentric pivot allows linear motion of the support arm 90 in a direction perpendicular with the vertical plane 138. In other words, linear motion of the support arm 90 moves the band saw 11 toward the clamp assembly 102. In other embodiments, the eccentric pivot may be replaced with a pivot pin that solely allows rotational motion. In such embodiments, the support arm 90 can solely pivot about the miter axis 152. The miter axis 152 is located within a reference plane oriented parallel to each of the drive wheel axis 78 and the driven wheel axis 79. Additionally, the reference plane extends through the opening 58 in the housing 14 of the band saw 11. In other words, the miter axis 152 is proximate a center of the base 98 and a center of the band saw 11. The support arm 90, and therefore the band saw 11, are pivotable about the miter axis 152 between a first miter angle and a second miter angle. In the first miter angle, the band saw 11 is at a first angle relative to the vertical plane 138. In the second miter angle, the band saw 11 is at a second angle relative to the vertical plane 138, the first angle is different than the second angle. The vertical plane 138 extends through the opening 58 of the housing 14 in each of the first miter angle and the second miter angle. The vertical plane 138 and the flat surface 136 of the second jaw 128 are generally aligned with a rear surface of the opening 58 for miter angles between the first miter angle and the second miter angle. Therefore, an entire length of the opening 58 is available during the cutting operation, increasing a cutting capacity of the band saw 11.

With reference to FIGS. 1-2 and 9, in operation, the user pivots the band saw 11 about the chop axis 94 to the raised position. The user places the workpiece between the first jaw 124 and the second jaw 128 of the clamp assembly 102, and moves the first jaw 124 toward the second jaw 128 to clamp the workpiece. The user pivots the band saw 11 about the miter axis 152 to a desired angle. The desired angle corresponds to a cut angle for the workpiece. Once the band saw 11 is at the desired angle, the user depresses the trigger 44 to activate the motor 18 and drive the saw blade 34 through the opening 58. The user moves the band saw 11 from the raised position to the lowered position, performing the cutting operation. Once at the lowered position, further movement of the band saw 11 is inhibited. The user moves the band saw 11 from the lowered position to the raised position and releases the trigger 44.

Since the miter axis 152 is proximate the center of the band saw 11, the miter axis 152 provides a more uniform arc-path. The arc-path limits the cutting capacity of the band saw 11. Due to the location of the miter axis 152, the band saw 11 has an improved cutting capacity. For example, when the band saw 11 is pivoted about the miter axis 152 to a 45 degree miter angle (i.e., when the saw blade 34 defines a 45 degree angle with the vertical plane 138), the band saw 11 may cut a pipe having a diameter between 45 mm and 50 mm. When the band saw 11 is pivoted about the miter axis 152 to a 0 degree miter angle (i.e., when the saw blade 34 defines a 90 degree angle with the vertical plane 138), the band saw 11 may cut a pipe having a diameter between 120 mm and 125 mm. In other embodiments, the cutting capacity of the band saw 11 may differ.

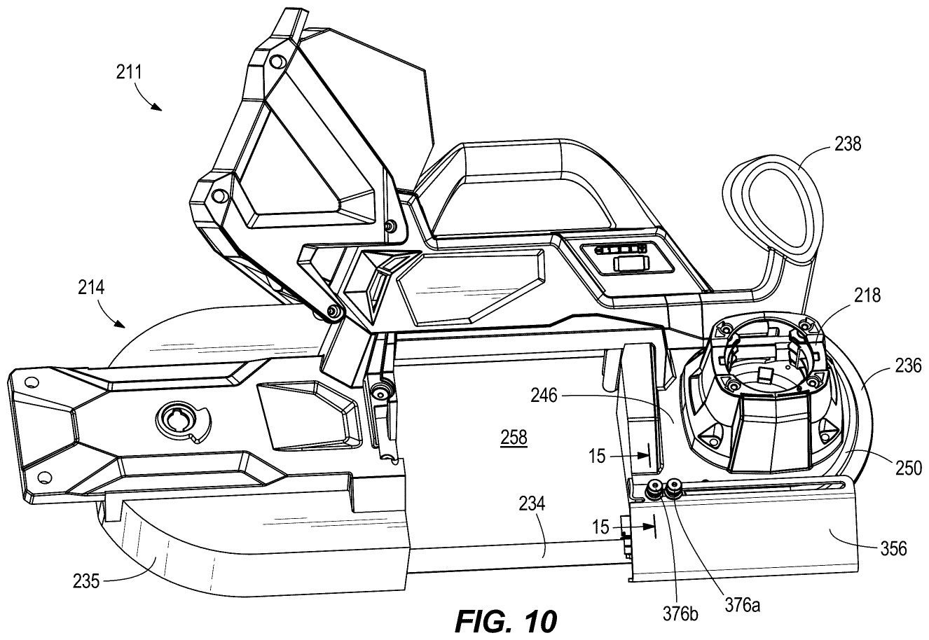

FIGS. 10-14 illustrate another band saw 211 configured to be pivotably coupled to the table 12 of the benchtop band saw 10 of FIGS. 1 and 2. The band saw 211 is similar to the band saw 11 of FIGS. 1-4; therefore, like structure will be identified by like reference numbers plus “200.”

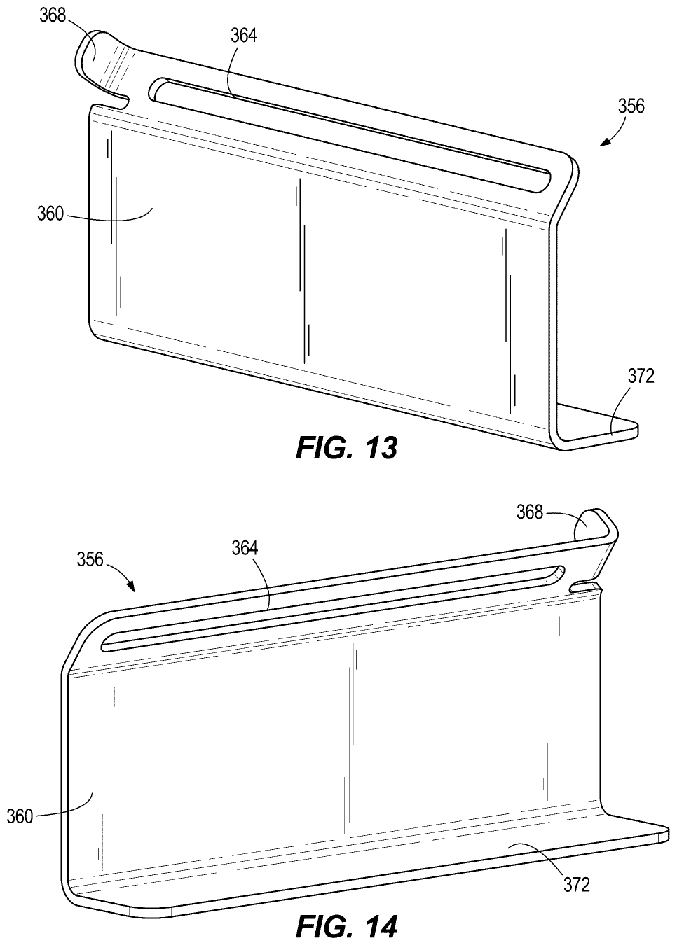

The band saw 211 includes a blade guard 356 movably coupled to a housing 214 of the band saw 211. More specifically, the blade guard 356 is movably coupled to a deck 246 of the housing 214 proximate a second end 236 of the housing 214, where a drive wheel 270 of the band saw 211 is located. The blade guard 356 has a body 360 with a slot 364 defined within a top portion of the body 360, a tab 368 extending from the top portion of the body 360, and a base 372 integrally formed with a bottom portion of the body 360 (FIGS. 13 and 14). In the illustrated embodiment, the base 372 of the blade guard 356 extends perpendicular from the body 360 of the blade guard 356. In other embodiments, the base 372 of the blade guard 356 may extend obliquely from the body 360 of the blade guard 356. As such, the blade guard 356 is configured to cover or shield a user from a portion of a continuous band saw blade 234 not being used to cut a workpiece during operation of the bandsaw 211.

With reference to FIGS. 10, 12, and 15, the blade guard 356 is fastened to the housing 214 of the band saw 211 by two fasteners 376a, 376b that extend through the slot 364 of the blade guard 356. In particular, the fasteners 376a, 376b extend through the slot 364 and are threaded to the deck 246. As such, the blade guard 356 is indirectly coupled to the housing 214 of the band saw 211 by the fasteners 376a, 376b and able to move with respect to the housing 214.

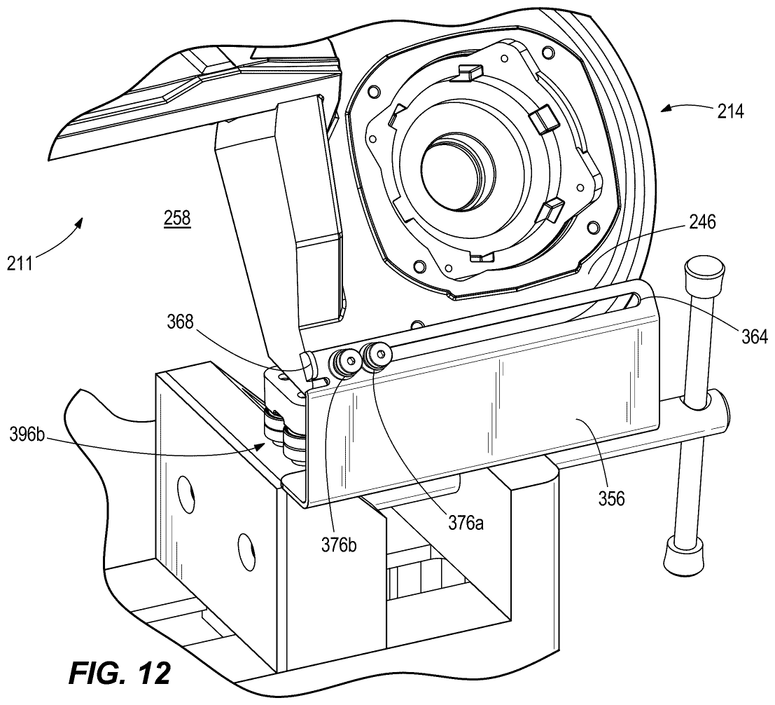

The blade guard 356 is slidable between a first position (i.e., a retracted position) and a second position (i.e., an extended position). In the first position, as shown in FIG. 12, the blade guard 356 is adjusted furthest rearward such that the blade guard 356 does not block an opening 258 disposed between a first end 235 of the housing 214 and a second end 236 of the housing 214. In the second position, the blade guard 356 is adjusted forward such that the blade guard 356 blocks at least a portion of the opening 258. The blade guard 356 is slidable between the first position and the second position by the user to block varying amounts of the opening 258. More specifically, the user may grasp the tab 368 to move the blade guard 356 to a desired position in which the blade guard 356 at least partially blocks the opening 258 depending on a size of the workpiece being cut.

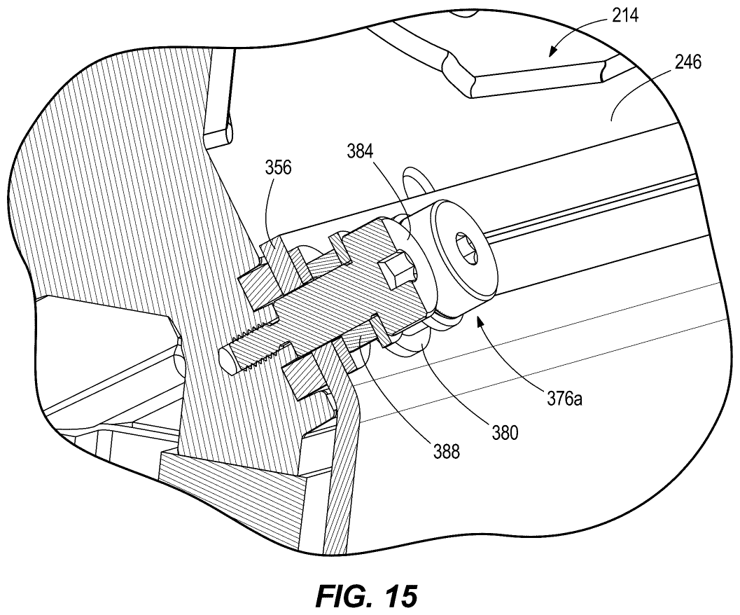

The band saw 211 further includes a biasing member 380 disposed between the blade guard 356 and the fasteners 376a, 376b (FIG. 15). More specifically, the biasing member 380 is disposed between a head 384 of each fastener 376a, 376b and a top surface 388 of the blade guard 356. In some embodiments, the biasing member 380 is a wave spring. In other embodiments, the biasing member 380 is a rubber bushing. The biasing member 380 preloads the blade guard 356 against the deck 246 of the band saw 211 to create friction between the blade guard 356 and the deck 246, and thereby automatically lock the blade guard 356 in a desired position. To slide the blade guard 356 with respect to the housing 214 of the band saw 211, the user may grasp the tab 368 to push or pull the blade guard 356 toward the opening 258 or away from the opening 258 with a sufficiently high force that is able to overcome the friction created between the blade guard 356 and the housing 214 by the biasing member 380.

In operation, the user pivots the band saw 211 to the raised position. The user then places a workpiece between the first jaw 124 and the second jaw 128 of the clamp assembly 102 and moves the first jaw 124 toward the second jaw 128 to clamp the workpiece. The user grasps the tab 368 of the blade guard 356 to move the blade guard 356 to a desired position between the first position and the second position. Once the user releases the blade guard 356 and the blade guard 356 is motionless, the friction created between the blade guard 356 and the housing 214 of the band saw 211 by the biasing member 380, maintains the blade guard 356 in the desired position without requiring any further action from the user to lock the blade guard 356 in place. Further, the user pivots the band saw 211 to a desired angle corresponding to a cut angle for the workpiece. Once the band saw 211 is at the desired angle, the user engages an actuator to activate the motor 218 and drive the saw blade 234 through the opening 258. The user moves the band saw 211 from the raised position to the lowered position, performing the cutting operation. Once at the lowered position, further movement of the band saw 211 is inhibited. The user moves the band saw 211 from the lowered position to the raised position and disengages the actuator. In some embodiments, the band saw 211 can be used without the table 12.

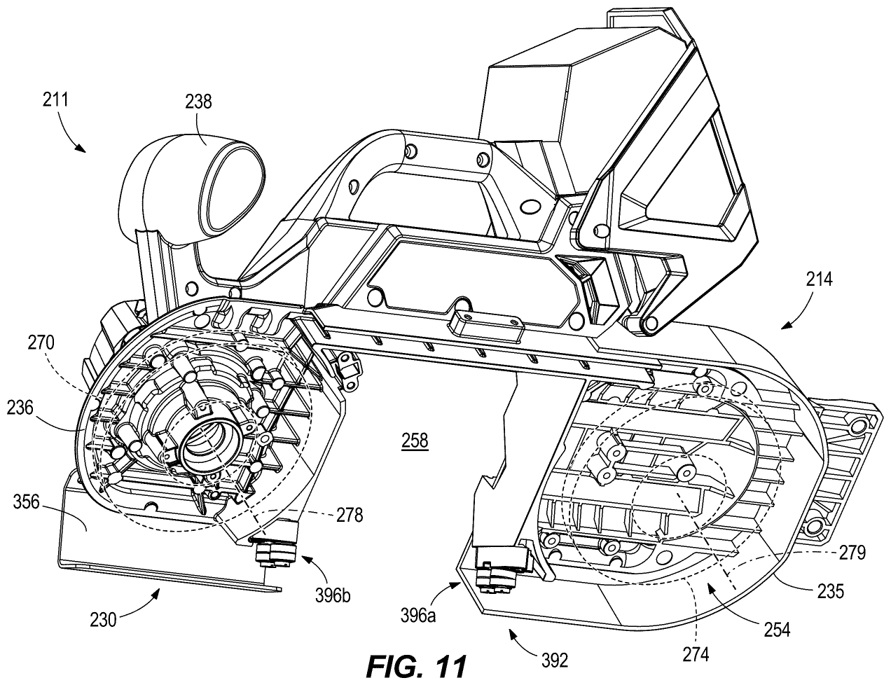

With reference to FIG. 11, the band saw 211 includes a blade guide assembly 392 having a first bearing set 396a and a second bearing set 396b disposed on each side of the opening 258. The first and second bearing sets 396a, 396b engage opposing sides of the saw blade 234 and thereby support the saw blade 234 as the blade 234 enters and exits the opening 258 during operation.

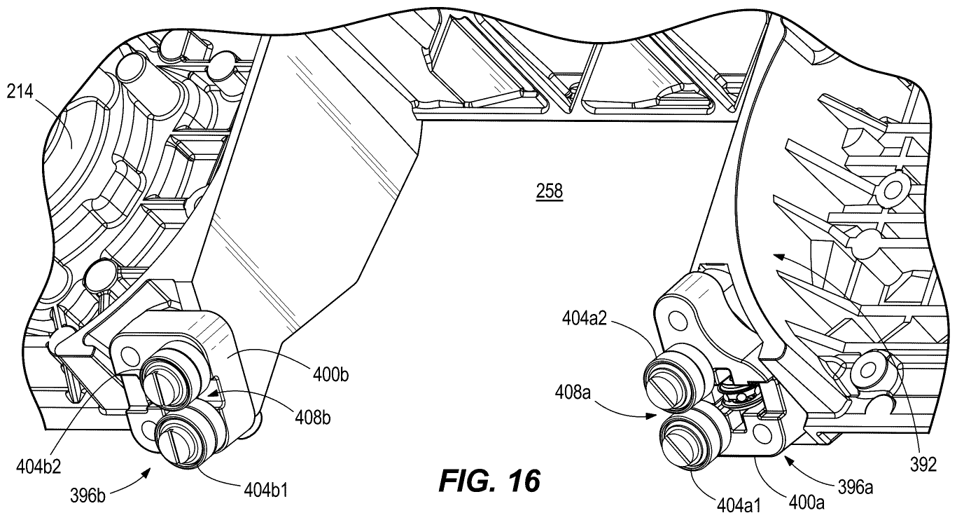

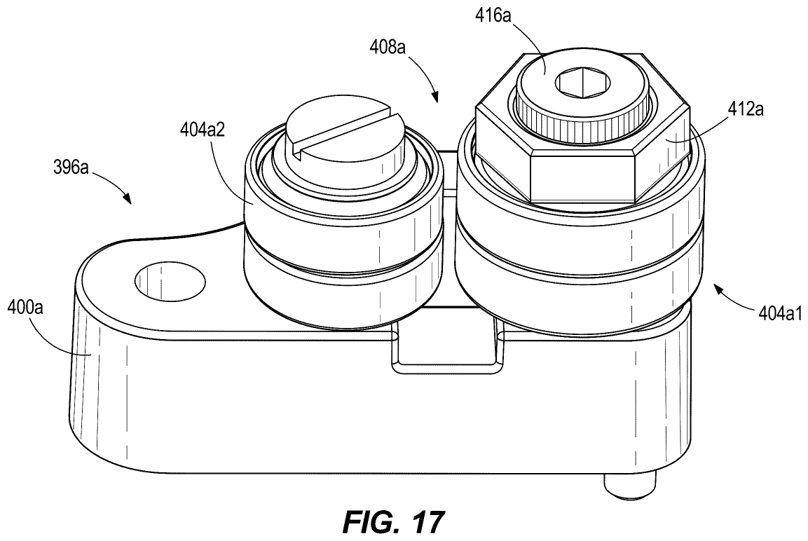

With reference to FIGS. 16 and 17, the first bearing set 396a includes a first mounting block 400a coupled to the housing 214 of the band saw 211 and a first pair of bearings 404a1, 404a2 rotatably supported by the first mounting block 400a. The second bearing set 396b includes a second mounting block 400b coupled to the housing 214 of the band saw 211 and a second pair of bearings 404b1, 404b2 rotatably supported by the second mounting block 400b. The first mounting block 400a is disposed proximate a first end of the opening 258 and the second mounting block 400b is disposed proximate a second end of the opening 258. A gap 408a, 408b, through which the saw blade 234 extends, is respectively defined between the bearings 404a1, 404a2 of the first bearing set 396a and the bearings 404b1, 404b2 of the second bearing set 396b.

With reference to FIG. 17, a first bearing 404a1 of the first bearing set 396a is adjustable. Specifically, a user may adjust the position of the first bearing 404a1 relative to the first mounting block 400a for varying the size of the gap 408a to accommodate saw blades of different thicknesses. The first bearing 404a1 includes an eccentric sleeve 412a that is rotatable by a user to move the first bearing 404a1 toward or away from the second bearing 404a2 of the first bearing set 396a. Also, the first bearing 404a1 has a fastener 416a for axially retaining the first bearing 404a1 to the first mounting block 400a. More specifically, when the eccentric sleeve 412a is rotated in a first direction, the first bearing 404a1 is moved away from the second bearing 404a2 to increase the size of the gap 408a. When the eccentric sleeve 412a is rotated in a second direction opposite the first direction, the first bearing 404a1 is moved toward the second bearing 404a2 to reduce the size of the gap 408a. As such, adjusting the position of the first bearing 404a1 relative to the second bearing 404a2 will reduce the occurrence of blade wobbling by the saw blade 234. Although the second bearing set 396b is not shown in FIG. 17, in some embodiments, the second bearing set 396b can be similar to the first bearing set 396a (that is, with one of the bearings 404b1, 404b2 being adjustable relative to the other to adjust the width of the gap 408b). The first and second bearing sets 396a, 396b can also be incorporated in the band saw 11 of FIGS. 1-9. In some embodiments, the band saw 11 can be used without the table 12.

Although the invention has been described in detail with reference to certain preferred embodiments, variations and modifications exist within the scope and spirit of one or more independent aspects of the invention as described.

Various features of the present invention are set forth in the following claims.

What is claimed is:

1. A benchtop band saw comprising:
a base;
a clamp assembly coupled to the base and configured to hold a workpiece;
a support arm pivotably coupled to the base about a miter axis that extends perpendicular to the base; and
a band saw coupled to the support arm and moveable relative to the support arm and the base between a raised position and a lowered position for performing a cutting operation on the workpiece, the band saw including
a housing defining an opening in which the workpiece is at least partially receivable during the cutting operation,
a motor positioned within the housing,
a first wheel supported by the housing for rotation about a first wheel axis, the first wheel being coupled to the motor to receive torque therefrom,
a second wheel supported by the housing for rotation about a second wheel axis, and
a band saw blade extending around the first wheel and the second wheel and traveling in a continuous loop around the first wheel and the second wheel, the band saw blade traversing the opening in the housing,
wherein the miter axis is located within a reference plane oriented parallel to each of the first wheel axis and the second wheel axis, and
wherein the reference plane extends through the opening in the housing when the band saw is in at least the lowered position.

2. The benchtop band saw of claim 1, wherein the band saw is pivotable about the miter axis between a first miter angle and a different, second miter angle, wherein the clamp assembly includes a stationary jaw defining a vertical plane, and wherein the vertical plane extends through the opening in the housing in at least one of the first miter angle and the second miter angle when the band saw is in each of the raised position and the lowered position.

3. The benchtop band saw of claim 2, wherein the vertical plane extends through the opening in the housing in each of the first miter angle and the second miter angle when the band saw is in each of the raised position and the lowered position.

4. The benchtop band saw of claim 1, wherein the band saw is pivotably coupled to the support arm about a chop axis oriented perpendicular to the miter axis.

5. The benchtop band saw of claim 4, wherein the support arm has a support arm base and a band saw mount pivotably coupled to the support arm base by a pivot joint that defines the chop axis, the support arm base is coupled to the base.

6. The benchtop band saw of claim 1, wherein the miter axis is proximate a center of the band saw.

7. The benchtop band saw of claim 1, wherein the base includes a miter angle scale and a material cut-off scale located on a top surface of the base.

8. A benchtop band saw comprising:
a base;
a clamp assembly coupled to the base and configured to hold a workpiece; and
a band saw moveably coupled to the base between a first position and a second position, the band saw including
a housing having
a first end moveably coupled to the base,
an opposite, second end, and
an opening in which the workpiece is at least partially receivable during a cutting operation, the opening being located between the first end and the second end,
a motor positioned within the housing,
a first wheel supported by the housing for rotation about a first wheel axis, the first wheel being coupled to the motor to receive torque therefrom,
a second wheel supported by the housing for rotation about a second wheel axis,
a band saw blade extending around the first wheel and the second wheel and traveling in a continuous loop around the first wheel and the second wheel, the band saw blade traversing the opening in the housing and configured to cut the workpiece as the band saw moves from the first position to the second position,
a handle coupled to the housing proximate the first end, the handle having a mount portion fixed to the housing and a grip portion extending transverse to the mount portion, the grip portion including a rear surface facing the first end of the housing, and
a trigger protruding from the rear surface of the grip portion of the handle, the trigger being configured to actuate the motor when depressed.

9. The benchtop band saw of claim 8, wherein the handle is a pommel handle.

10. A benchtop band saw comprising:
a base;
a clamp assembly coupled to the base and configured to hold a workpiece; and
a band saw moveably coupled to the base, the band saw including
a housing having
a first end moveably coupled to the base,
an opposite, second end, and
an opening in which the workpiece is at least partially receivable during a cutting operation, the opening being located between the first end and the second end,
a motor positioned within the housing,
a first wheel supported by the housing for rotation about a first wheel axis, the first wheel being coupled to the motor to receive torque therefrom,
a second wheel supported by the housing for rotation about a second wheel axis,
a band saw blade extending around the first wheel and the second wheel and traveling in a continuous loop around the first wheel and the second wheel, the band saw blade traversing the opening in the housing and configured to cut the workpiece, and
a blade guard movably coupled to the housing between a first position and a second position, wherein the blade guard is preloaded against the housing to lock the blade guard in a desired position when the blade guard is motionless.

11. The benchtop band saw of claim 10, wherein the band saw further includes a biasing member configured to preload the blade guard against the housing to lock the blade guard in the desired position.

12. The benchtop band saw of claim 11, wherein the band saw further includes a fastener configured to fasten the blade guard to the housing of the band saw, and wherein the biasing member is disposed between the fastener and the blade guard.

13. The benchtop band saw of claim 12, wherein the biasing member is a wave spring.

14. The benchtop band saw of claim 12, wherein the biasing member is a rubber bushing.

15. The benchtop band saw of claim 10, wherein in the first position, the blade guard is positioned with the opening being unblocked, and wherein in the second position, the blade guard is positioned with at least a portion of the opening being blocked by the blade guard.

16. A benchtop band saw comprising:
a base;
a clamp assembly coupled to the base and configured to hold a workpiece; and
a band saw moveably coupled to the base, the band saw including
a housing having
a first end moveably coupled to the base,
an opposite, second end, and
an opening in which the workpiece is at least partially receivable during a cutting operation, the opening being located between the first end and the second end,
a motor positioned within the housing,
a drive wheel assembly rotationally driven by the motor, the drive wheel assembly including a drive wheel and a driven wheel,
a band saw blade extending around the drive wheel assembly and traveling in a continuous loop around the drive wheel assembly, the band saw blade configured to pass through the opening of the housing to cut the workpiece, and
a blade guide assembly coupled to the housing and configured to support the band saw blade as the band saw blade passes through the opening, the blade guide assembly including a first bearing set disposed on a first end of the opening and a second bearing set disposed on a second end of the opening, wherein the first bearing set includes a first bearing and a second bearing separated from each other by a gap within which the band saw blade is supported, and wherein the first bearing is adjustable relative to the second bearing to adjust a width of the gap.

17. The benchtop band saw of claim 16, wherein the first bearing includes an eccentric sleeve configured to be rotated for moving the first bearing relative to the second bearing.

18. The benchtop band saw of claim 17, wherein the eccentric sleeve is rotatable between a first direction, in which the first bearing is moved toward the second bearing, and a second direction, in which the first bearing is moved away from the second bearing.

19. The benchtop band saw of claim 16, wherein the gap is a first gap, wherein the second bearing set includes a first bearing and a second bearing separated from each other by a second gap within which the band saw blade is supported, and wherein the first bearing of the second bearing set is adjustable relative to the second bearing of the second bearing set to adjust a width of the second gap.

20. The benchtop band saw of claim 19, wherein each of the first and second bearing sets further includes a mounting block coupled to the housing of the band saw and configured to rotatably support the first bearing and the second bearing of the respective bearing sets.
